(19) United States
(12) Patent Application Publication
(10) Pub. No.: US 2017/0323383 A1
(43) Pub. Date: Nov. 9, 2017

(54) SYSTEMS AND METHODS FOR PROVIDING INFORMATION SYMMETRY

(71) Applicant: Homie, Inc., Draper, UT (US)

(72) Inventor: Matthew J. Thorne, Salt Lake City, UT (US)

(21) Appl. No.: 15/587,659

(22) Filed: May 5, 2017

Related U.S. Application Data
(60) Provisional application No. 62/332,335, filed on May 5, 2016.

(51) Int. Cl. G06Q 40/04; G06Q 50/16

(52) U.S. Cl. CPC G06Q 40/04; G06Q 50/16

(57) ABSTRACT

Systems and methods are disclosed herein for presenting information to reduce information asymmetry between parties in a negotiation. A party portal obtains from a data source data that is relevant to a negotiation point of a negotiation script. The party portal presents the relevant data according to a first perspective of a first party profile. The party portal can present a suggested value for the negotiation point, according to the first party profile. The party portal also receives values provided by a first party for each negotiation point. The party portal also presents the relevant data according to a second perspective of a second party profile. The party portal can present a suggested value for the negotiation point, according to the second party profile. The party portal also receives values provided by a second party for each negotiation point. A manifestation of agreement of the parties is presented when the first party values for each negotiation point align with the second party values for each negotiation point.

### RELATED APPLICATIONS

The present application claims benefit of priority under 35 U.S.C. §119(e) of U.S. Provisional Patent Application No. 62/332,335, filed May 5, 2016, and titled “SYSTEMS AND METHODS FOR PROVIDING INFORMATION SYMMETRY,” which is hereby incorporated herein by reference in its entirety.

### TECHNICAL FIELD

The present disclosure relates to systems and methods for providing information symmetry, and more particularly to systems and methods for reducing information asymmetry during a dynamic negotiation.

### BACKGROUND

People are often wary and unwilling to enter into negotiations in areas where they are not experts because they lack appropriate information and experience to conduct an effective negotiation and obtain positive results. In such situations, people will often hire subject-matter experts as intermediaries and agents to negotiate on their behalf and provide recommendations at decision points. These intermediaries often are very expensive. Further, in many western cultures, in-person negotiations and haggling over prices are practices reserved for niche transactions such as buying cars, second-hand goods, and difficult-to-price unique items, such as real estate. Because such negotiations are rare, many western people are uncomfortable participating because they have neither the familiarity nor the expertise to feel confident they will reach a favorable or fair outcome.

Accordingly, systems and methods for providing information symmetry, and that can be used to facilitate a dynamic negotiation such as involving a transaction (e.g., a real estate transaction), may be desirable.

### SUMMARY

The present disclosure provides systems and methods for providing information symmetry, such as may be used to facilitate a dynamic negotiation or other exchange.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a block diagram illustrating a system for presenting information to reduce information asymmetry between parties in a negotiation, according to one embodiment of the present disclosure.

FIG. 2 is a block diagram of a buyer portal of a system for presenting information to reduce information asymmetry between parties in a negotiation, according to one embodiment of the present disclosure.

FIG. 3 is a block diagram of a seller portal of a system for presenting information to reduce information asymmetry between parties in a negotiation, according to one embodiment of the present disclosure.

FIG. 4 is a flow diagram of a method of electronically conducting a negotiation between parties, according to one embodiment.

FIG. 5 is a flow diagram of a method of electronically conducting a negotiation between parties, according to another embodiment.

FIG. 6 is a relational diagram of a dynamic database of a system for presenting information to reduce information asymmetry between parties in a negotiation, according to another embodiment.

FIG. 7 is a user interface of a buyer portal of a system for presenting information to reduce information asymmetry between parties in a negotiation, according to one embodiment of the present disclosure.

FIG. 8 is a user interface of a seller portal of a system for presenting information to reduce information asymmetry between parties in a negotiation, according to one embodiment of the present disclosure.

### DETAILED DESCRIPTION

People are often wary and unwilling to enter into negotiations in areas in which they may lack appropriate information and experience to feel confident in conducting an effective negotiation to obtain desirable results. Accordingly, a person in such a situation will often hire one or more subject-matter experts to advise and potentially function as an intermediary and/or agent. The hired expert(s) may negotiate on behalf of the person (e.g., the hiring party) and provide recommendations at decision points. These subject-matter experts can be very expensive and without guarantee or other assurance of a desired quality of service.

For example, a negotiation of a Residential Real Estate Purchase Contract (REPC) between a buyer and a seller includes several negotiation points. People will typically only buy or sell a home once every seven years. Because of the infrequency of participating in such negotiations, most people are not likely to be experts on current market trends and data that would allow them to be effective negotiators. Further, if an individual is buying or selling a home without an agent, the individual will often be negotiating with the other party's real estate agent, who is the perceived expert in the field and likely to have first-hand or better access to relevant data that can be used as an advantage in a negotiation.

Accordingly, systems and methods for providing information symmetry, and that can be used to facilitate a dynamic negotiation such as involving a transaction, may be desirable.

The present disclosure provides systems and methods for presenting information (e.g., highly tailored and real-time data) to reduce information asymmetry between parties in a negotiation. The disclosed systems include systems for electronically conducting a negotiation between multiple parties, and systems for providing information relevant to a negotiation. An electronic computerized interface may be provided where all negotiation points are presented privately to each party alongside real-time, hyper-focused and minutely relevant data focused on market conditions directly related to each negotiation point. By using a computer interface, each party to a negotiation will be shielded from in-person negotiation-related anxiety. Further, by receiving real-time data on each decision point of a negotiation (e.g., what 10-20 other users with similar cases have done in a similar negotiation situation or even an exact same negotiation situation), parties to a negotiation can become confident in making a negotiating decision based on their decision being within the norm of multiple other similar cases as shown by the real-time data. The disclosed systems and methods facilitate users gaining confidence in negotiating unfamiliar transactions by removing two of the biggest obstacles for typical users.

Typically a negotiation of an REPC begins with a buyer starting the negotiation by presenting an offer to the seller. The disclosed embodiments may include a user interface for the buyer that, through a series of questions presented alongside relevant data, takes the buyer step-by-step through input requirements for completing an offer. Each negotiation point can be presented alongside relevant data obtained from external data sources and/or compiled in a dynamic database. The relevant data may include purchased (from an external data source) or captured relevant data for each negotiation point as well as suggested input choices based on the data. For example, when a buyer is addressing a negotiation point that includes input of a purchase price, the disclosed embodiments can use the address of the target property to pull relevant data of recent listing and sales prices for similar properties in the area, as well as offer prices and percentage differences between listing, offer and final sale prices. The disclosed embodiments can then present the buyer with curated information based on such data to show what average listing prices, offer prices, and final sale prices are for similar properties. The mean offer price can be noted as a relevant starting position for the user's offer, with caveats about factors to be considered to increase or reduce this mean offer price. Such factors may include a particular home's upgrades (e.g., if the home includes an in-ground pool, that increases the average offer price by $10,000). The buyer can then select whether certain features and conditions apply to the target home based on his/her familiarity with the property. When certain features are selected or de-selected, the disclosed embodiments can present the user with a series of suggested additions or subtractions from the mean offer price. The buyer is further prompted to input a price based on all questions and relevant data presented. The disclosed embodiments may include a visible tally sheet of additions and subtractions based on features and conditions so that at a final step all relevant additions and subtractions can be easily accounted for to aid in providing a value for the offer price.

The disclosed embodiments then move on to a next negotiation point, for example, whether the seller will help pay any of the buyer's closing costs. Relevant data for similar properties in the area can be presented as before for the offer price, and the process can be repeated until the buyer has addressed and provided input for all negotiation points for a typical REPC offer. Ultimate decisions on data input for values of the negotiation points of the REPC offer will be left to the user, and users may ignore suggestions or input offer prices and other details that are outside the average or mean.

The disclosed embodiments can also offer suggested values labeled according to a style of negotiating the user would like to employ. These suggested values could be labeled as follows: “I need this deal,” “Market Average” and “Aggressive,” among other possible labels. Each suggested value of a negotiation point in the negotiation can feature one or more suggested values. In the case where three suggested values for a negotiation point, the three suggested values may deviate from the market average according to a formula corresponding to the negotiating style preference (e.g., a deviation by some percentage). The “I need this deal” suggested value can suggest for an offer price, for example, a number lower than market average, to help entice the seller to accept the buyer's offer. The “Market Average” suggested value may include a mean value according to the relevant data, and the “Aggressive” suggested value may include a more buyer-favorable choice. For instance, if the user is uncertain about three similar homes, and would pick any of the three depending on which home he/she could purchase for the least consideration, the user could select the aggressive suggestions for all offers and thereby test which seller is more motivated to sell and thereby may accept an aggressively low offer. The ability to know in real time what current market conditions are, based on the location, features, and condition of the target home, can help ensure that such user will not end up with an offer that is extremely unfavorable to the user, unless such user makes irrational decisions when moving through the process.

When all negotiating decisions are complete for an REPC offer and the negotiation points are addressed and values are provided, the disclosed embodiments may populate a relevant form with all user inputs and then prompt the user to give final approval and digitally sign the completed offer (if required by law or custom for the negotiation process). The REPC offer can then be presented to the seller, such as through a seller interface.

The disclosed embodiments may enable a seller, or a second party to the negotiation, to review the buyer values for each negotiation point of the REPC offer.

The disclosed embodiments may include a user interface to present an overview of all relevant details of the offer in a short outline and then prompt the user to “tour” the offer. When “touring” the offer, the seller may be presented with relevant information based on real-time data pulled from a database of purchased and/or captured data. For instance, as it relates to the value of a purchase-price negotiation point, the seller may be shown the listing price, the price noted in the offer just received, and the percentage difference between the two. The seller will then be shown, through the graphical user interface, how this offer compares to other offers received, if any, and to other offers (e.g., relevant data) on similar homes recently sold. If the offer is 5% below the listing price, and similar homes sold for an average of 3% below listing price, the interface will note that this offer is 2% below average for similar homes and provide the option of selecting an input for a counter-offer that matches or exceeds the mean of other sales in the area.

The disclosed embodiments may also take into account whether the seller's listing price is high or low compared to similar homes and algorithmically model such data to produce consistent results. The user will then be presented a series of options related to this negotiation point, such as “accept and move to next,” “counter,” “skip,” etc.

If the seller selects “counter,” another series of questions and decisions may be triggered. These questions and decisions may be similar to the original offer questions related to offer price, but may be specialized or otherwise tailored to generating a counter-offer.

Once the seller has completed the questions related to justifications for a higher or lower price, the seller can select a counter-offer price and choose whether to include the justifications in a cover letter. For instance, if the counter-offer is higher than the average sales price for similar homes, the seller may want to explain that a new $20,000 roof was installed last year.

This process is repeated for all relevant negotiation points according to a seller's perspective. Then, based on the user input, the disclosed embodiments may complete a counter-offer form by inserting the relevant data into the correct locations on the form. The form can then be presented for signature, if required, and sent to the buyer. The buyer can then be presented a similar experience to the seller, and the process repeated until both sides agree on all negotiation points, or one side terminates the negotiations.

When both sides have agreed through the interface on all negotiation points, the disclosed embodiments can combine all offers and counter-offers into a fully executed REPC that can then be sent to each party and all third parties that need a copy.

The present disclosure will be better understood from the detailed description provided below and from the drawings of various embodiments, methods, and examples herein. These specifics are provided for explanatory purposes that help the various embodiments of the disclosure to be better understood. The invention should therefore not be limited by the described embodiments, methods, and examples, but by all embodiments and methods within the scope and spirit of the invention as claimed.

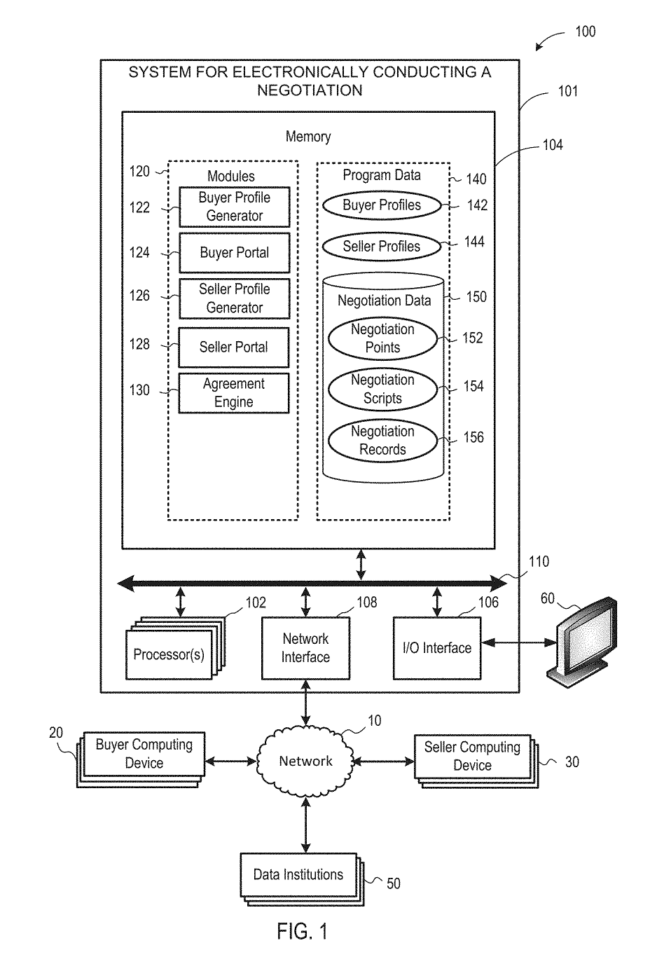

FIG. 1 is a block diagram of a system 100 for presenting information to reduce information asymmetry between parties in a negotiation, according to one embodiment of the present disclosure. The system 100 of FIG. 1 includes a central computing system 101 (or a system for electronically conducting a negotiation between multiple parties), which is in communication over a network 10 with buyer computing devices 20, seller computing devices 30, and data institutions 50 (or data sources). The system 101 may be an electronic negotiation system to reduce information asymmetry between parties to a negotiation, such as a system to provide information relevant to a negotiation. The system may be an electronic presentation system for presenting information relevant to a negotiation to parties in the negotiation.

The system 100 facilitates presentation of information and/or a negotiation through the system 101 for electronically conducting a negotiation between multiple parties.

The system 101 for electronically conducting a negotiation between multiple parties includes one or more processors 102, an electronic memory 104, an I/O interface 106, a network interface 108, and a system bus 110. The system 101 of FIG. 1 presents relevant information to parties in the negotiation.

The one or more processors 102 may include one or more general-purpose devices, such as an Intel®, AMD®, or other standard microprocessor. The one or more processors 102 may include a special-purpose processing device, such as ASIC, SoC, SiP, FPGA, PAL, PLA, FPLA, PLD, or other customized or programmable device. The one or more processors 102 perform distributed (e.g., parallel) processing to execute or otherwise implement functionalities of the present embodiments. The one or more processors 102 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The electronic memory 104 may include static RAM, dynamic RAM, flash memory, one or more flip-flops, ROM, CD-ROM, DVD, RAM, EPROM, EEPROM, disk, tape, or magnetic, optical, or other computer storage medium. The electronic memory 104 may include a plurality of program modules 120 and program data 140. The electronic memory 104 may be local to the system 101 or may be remote from the system 101 and/or distributed over the network 10.

The program modules 120 may include all or portions of other elements of the system 101. The program modules 120 may run multiple operations concurrently or in parallel by or on the one or more processors 102. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like.

The program data 140 stored on the electronic memory 104 may include data generated by the system 101, such as by the program modules 120 or other modules. The stored program data 140 may be organized as one or more databases.

The I/O interface 106 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display 60, printer, speech or text synthesizer, switch, signal line, or other hardware with accompanying firmware and/or software.

The network interface 108 may facilitate communication with other computing devices and/or networks 10, such as the Internet and/or other computing and/or communications networks. The network interface 108 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network interface 108 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 110 may facilitate communication and/or interaction between the other components of the system 101, including the one or more processors 102, the electronic memory 104, the I/O interface 106, and the network interface 108.

As noted, the system 101 includes various program modules 120 (or engines, elements, or components) to implement functionalities of the system 101 and to generate, access, and/or manipulate the program data 140 stored in the electronic memory 104. The program modules 120 can include a buyer profile generator 122, a buyer portal 124, a seller profile generator 126, a seller portal 128, and an agreement engine 130.

The buyer profile generator 122 may collect buyer profile data, which may include a name, contact information, demographic data, and/or negotiation style preference. The buyer profile generator 122 may compile the buyer profile data for storage in a buyer profile 142 in program data 140 stored in the electronic memory 104.

The buyer portal 124 may, by the one or more processors 102, traverse a set of negotiation points 152. For each negotiation point 152 along the traversal of the set, the buyer portal 124 is to obtain relevant data from a data source such as the data institutions 50 and/or a database of other negotiation records 156. The relevant data obtained can be presented to parties to the negotiation according to a desired perspective view. The buyer portal 124 may include algorithms and/or engines to sort the large data set and preselect the relevant data to output. The buyer portal 124 presents a buyer perspective view of the relevant data obtained and/or preselected for the negotiation point. The buyer portal 124 also receives for storage in the electronic negotiation record 156 in the electronic memory 104 a buyer input value for the negotiation point.

The seller profile generator 126 may collect seller profile data, which may include name, contact information, demographic data, and negotiation style preference. The seller profile generator 126 may compile the seller profile data for storage in a seller profile 144 in program data 140 stored in the electronic memory 104.

The seller portal 128 may, by the one or more processors 102, traverse the set of negotiation points 152. For each negotiation point 152, the seller portal 128 is to present an associated buyer input value for the negotiation point 152. The seller portal 128 obtains relevant data from the data source, such as the data institutions 50 and/or other negotiation records 156. The seller portal 128 can present a seller perspective view of the relevant data obtained for the negotiation point 152. The seller portal 128 can receive for storage in the electronic negotiation record 156 in the electronic memory 104 a seller input value for the negotiation point 152.

The agreement engine 130 can compare the seller input value of each negotiation point 152 with a buyer value for that negotiation point 152, determine that agreement is achieved, and present a manifestation that the agreement is achieved. The agreement engine 130 may present the manifestation to the display 60. The agreement engine 130 may also present the manifestation to one or both of the buyer computing device 20 and the seller computing device 30 over the network 10.

The program data 140 can include user profiles, such as buyer profiles 142 and seller profiles 144, and negotiation data 150. The negotiation data 150 may include negotiation points 152, negotiation scripts 154, and negotiation records 156. The negotiation points 152 may specify or otherwise define a point on which consensus of two or more parties may be desirable to achieve an overall agreement about a matter that is a subject of a negotiation. A negotiation point 152 may describe a type of value to be determined and at what level of matching of user values may be desirable for consensus to be achieved for the negotiation point 152. A user value for a negotiation point may be a number, a symbol, a text string (e.g., a word, a phrase, a sentence description, geographic coordinates), or any suitable representation of a statement or description of a user position for the negotiation point. For example, “Seller to pay closing costs,” may be a value for a negotiation point re payment of closing costs for a REPC.

The negotiation scripts 154 may organize a plurality of negotiation points 152. A negotiation script 154 may specify a set of negotiation points 152 to be included in a negotiation to reach an agreement. The negotiation records 152 may include information about completed negotiations and may include information such as: a number of exchanges, initial values (e.g., a starting offer price), final values (e.g., ultimate purchase price), and/or external values (e.g., a listing price), among other types of information. The negotiation records 152 may be organized as, and/or include, a dynamic database and may include acquired data (e.g., purchased or otherwise gathered from a third-party such as a data institution) and collected data tracked by the system 101 in the course of prior negotiations. The acquired data and collected data may be normalized and organized as negotiation records that are searchable and/or otherwise accessible.

Examples of data institutions 50 include, but are not limited to, government data and/or regulatory institutions, depository institutions, certified credit bureaus, higher education institutions, public record institutions, commercial data suppliers, data collected by web crawlers, and any other data source for obtaining relevant data, such as market data and information on similar market transactions.

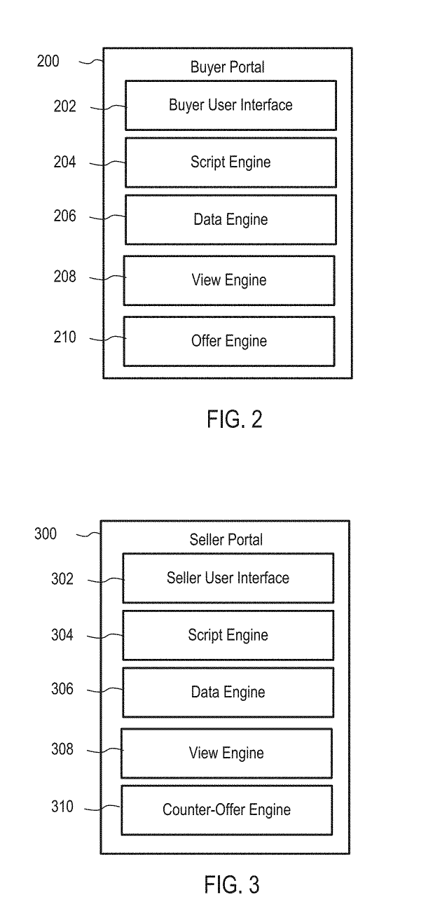

FIG. 2 is a block diagram of a buyer portal 200 of a system for presenting information to reduce information asymmetry between parties in a negotiation, according to one embodiment of the present disclosure. The buyer portal 200 may include a buyer user interface 202, a script engine 204, a data engine 206, a view engine 208, and an offer engine 210.

The buyer user interface 202 provides a presentation of relevant data to a user (e.g., a buyer) and provides user input components for the user to provide values for negotiation points. The buyer user interface 202 provides the presentation of relevant data according to a buyer profile.

The script engine 204 traverses a set of negotiation points of a negotiation script. The script engine 204 can include or otherwise reference an ordered decision tree (e.g., the negotiation script) that can be used to traverse a set of negotiation points. The ordered decision tree and/or the set of negotiation points can be stored in a database local to the buyer portal 200 and/or a system hosting the buyer portal 200. In other embodiments, the set of negotiation points can be stored in a database external to the system hosting the buyer portal 200. The ordered decision tree can indicate to the script engine 204 to present a first negotiation point to the buyer before a second negotiation point is presented to the buyer. In some examples, the ordered decision tree can indicate to the script engine 204 to present a second negotiation point to a buyer contingent on the result (e.g., responses from the buyer and/or the seller) of a first negotiation point.

The ordered decision tree can also indicate to the script engine 204 to provide multiple negotiation points simultaneously to the buyer. For example, a first negotiation point and a second negotiation point can be presented to a buyer concurrently. The concurrent presentation of negotiation points can be useful when one or more negotiation points are related and/or associated. For example, a first negotiation point and a second negotiation point can be associated when the second negotiation point only exists based on the result of the first negotiation point. The multiple negotiation points can be generated and presented to the buyer based on the results of a single negotiation point or the results of multiple negotiation points. For example, a third negotiation point and a fourth negotiation point can be concurrently presented to a buyer based on the result of a first negotiation point and/or based on the results of the first negotiation point and the second negotiation point.

The data engine 206 collects or otherwise obtains negotiation data pertaining to other negotiations, including relevant data that is of particular relevance to negotiation points of the negotiation script. The data engine 206 may aid in determining the relevant data. The data engine 206 can collect the negotiation data from a single data source and/or from multiple data sources. The single data source and/or the multiple data sources can be local to the system hosting the data engine 206 and/or external to the system hosting the data engine 206. The data sources can be external to the system hosting the data engine 206, for example, when the negotiation data is provided to the data engine 206 via a network connection (e.g., through a network interface of the system hosting the data engine 206). The data sources can be external to the system hosting the data engine 206 when the data sources are coupled to the system as input devices such as a universal serial bus (USB) device.

The multiple data sources can be independent and/or associated data sources. For example, the multiple data sources can be independent when each data source is hosted by a different entity. For example, a first bank may host a first database (e.g., data source) in a first server and a second bank that is different from the first bank may host a second database (e.g., data source) in a second server. The data sources can be associated when, for example, a first database and a second database are hosted by a same server of a bank.

The view engine 208 may aid in determining the relevant data to provide a buyer perspective view of the relevant data. The view engine 208 may further tailor the buyer perspective view according to a buyer profile. For example, the view engine 208 can select the type of data to provide, a screen format associated with the data, and/or a presentation type associated with the data. For example, the type of data can include a maximum sales price, a minimum sales price, and/or a mean sale price of a plurality of sale prices. The view engine 208 can determine the sale prices to include in the plurality of sale prices. The screen format can include the arrangement of the data to be presented to a buyer. For example, the data can be presented before a summary or after a summary. The data can be presented using a plurality of fonts, font sizes, images, and/or animations. The presentation type can include visual and/or audio presentations. The visual presentations can include slide presentations, video presentations, graphs, charts, lists, and/or any other type of visual presentation. The use of the type of data, the screen format, and/or the presentation type can be selected based on a buyer's profile.

The offer engine 210 may collect values for each negotiation point of the negotiation script and compile the values into a buyer offer that can be communicated to a seller. The buyer offer may be compiled based on a buyer's profile and/or a seller's profile. The compilation of the buyer offer may be reviewed by a buyer before the offer is transmitted to the seller. The buyer offer may be modified by a buyer during the review process.

FIG. 3 is a block diagram of a seller portal 300 of a system for presenting information to reduce information asymmetry between parties in a negotiation, according to one embodiment of the present disclosure. The seller portal 300 may include a seller user interface 302, a script engine 304, a data engine 306, a view engine 308, and a counter-offer engine 310.

The seller user interface 302 provides a presentation of relevant data to a user (e.g., a seller) and provides user input components for the user to provide values for negotiation points. The seller user interface 302 provides the presentation of relevant data according to a seller profile.

The script engine 304 traverses the set of negotiation points of the same negotiation script traversed by the script engine 204 of the buyer portal 200. The script engine 304 can include or otherwise reference an ordered decision tree (e.g., the negotiation script) that can be used to traverse a set of negotiation points. The ordered decision tree and/or the set of negotiation points may be the same as that used by the buyer portal 200 and/or the system hosting the buyer portal 200 of FIG. 2. The ordered decision tree can indicate to the script engine 304 to present a first negotiation point to the seller before a second negotiation point is presented to the seller. In some examples, the ordered decision tree can indicate to the script engine 304 to present a second negotiation point to the seller contingent on the result (e.g., responses from the buyer and/or the seller) of a first negotiation point.

The ordered decision tree can also indicate to the script engine 304 to provide multiple negotiation points simultaneously to the seller, such as when one or more negotiation points are related and/or associated. The multiple negotiation points can be generated and presented to a seller based on the results of a single negotiation point or the results of multiple negotiation points. For example, a third negotiation point and a fourth negotiation point can be concurrently presented to a buyer and/or seller based on the result of a first negotiation point and/or based on the results of the first negotiation point and the second negotiation point.

The data engine 306 collects or otherwise obtains negotiation data pertaining to other negotiations, including relevant data that is of particular relevance to negotiation points of the negotiation script. The data engine 306 may aid in determining the relevant data. The data engine 306 can collect the data from a single data source and/or from multiple data sources. The single data source and/or the multiple data sources can be local to the system hosting the data engine 306 and/or external to the system hosting the data engine 306. The data sources can be external to the system hosting the data engine 306, for example, when the negotiation data is provided to the data engine 306 via a network connection (e.g., through a network interface of the system hosting the data engine 306). The data sources can be external to the system hosting the data engine 306 when the data sources are coupled to the system as input devices such as a universal serial bus (USB) device.

The multiple data sources can be independent and/or associated data sources. For example, the multiple data sources can be independent when each data source is hosted by a different entity. For example, a first bank may host a first database (e.g., data source) in a first server and a second bank that is different from the first bank may host a second database (e.g., data source) in a second server. The data sources can be associated when, for example, a first database and a second database are hosted by a same server of a bank.

The view engine 308 may aid in determining the relevant data to provide a seller perspective view of the relevant data. The view engine 308 may further tailor the seller perspective view according to a seller profile. For example, the view engine 308 can select the type of data to provide, a screen format associated with the data, and/or a presentation type associated with the data. The data can be presented using a plurality of fonts, font sizes, images, and/or animations. The presentation type can include visual and/or audio presentations. The visual presentations can include slide presentations, video presentations, graphs, charts, lists, and/or any other type of visual presentation. The use of the type of data, the screen format, and/or the presentation type can be selected based on a buyer's profile.

The counter-offer engine 310 may collect values for each negotiation point of the negotiation script and compile the values into a counter-offer for the buyer. The counter-offer may be compiled based on a seller's profile and/or a buyer's profile. The compilation of the counter-offer may be reviewed by the seller before the offer is transmitted to the buyer. The seller offer may be modified by a seller during the review process.

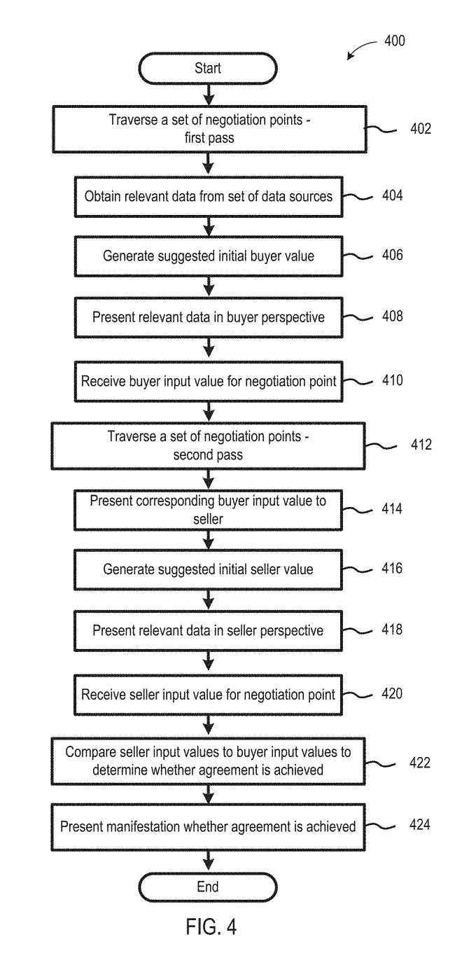

FIG. 4 is a flow diagram of a computer-implemented method 400 of electronically conducting a negotiation between parties, according to one embodiment. A set of negotiation points are traversed 402 according to a negotiation script. The negotiation points and/or script are stored electronically in a memory accessible by one or more processors. For each negotiation point of the set of negotiation points, relevant data is obtained 404, relevant data is processed to generate 406 a suggested initial buyer value, relevant data is presented 408 to the buyer, and buyer input values are received 410 for the negotiation point.

More particularly, relevant data is obtained 404 over an electronic communication network from a first set of data sources pertaining to the negotiation point. The relevant data for the negotiation point is processed to generate 406 a suggested initial buyer value for the negotiation point. The relevant data for the negotiation point is also presented 408 in a buyer perspective view. The buyer perspective view presents the data in a manner to enable the buyer to quickly compare data against similar negotiation points from similar negotiations. For example, a buyer may be presented a buyer perspective view of sales prices for homes in a similar area to a subject property and within a time period. The buyer perspective view may be configured according to a buyer profile including negotiation preferences. A buyer input value is received 410 for the negotiation point.

The set of negotiation points are traversed 412 in a second pass according to the negotiation script. For each negotiation point of the set of negotiation points, the corresponding buyer input value is presented 414 to the seller. The relevant data is processed to generate 416 a suggested initial seller value that can be compared to the buyer input value; relevant data is presented 418 to the seller; and seller input values are received 420 for the negotiation point. The seller perspective view presents the data in a manner to enable the seller to quickly compare data against similar negotiation points from similar negotiations. For example, a seller may be presented a seller perspective view of offer prices and/or ultimate sales prices as compared to listing prices for homes in a similar area to a subject property and within a time period. The seller perspective view may be configured according to a seller profile including negotiation preferences.

The seller input value of each negotiation point is compared 422 with the buyer input value for that negotiation point to determine whether agreement is achieved.

If agreement is achieved, a manifestation of a reached agreement is presented 424.

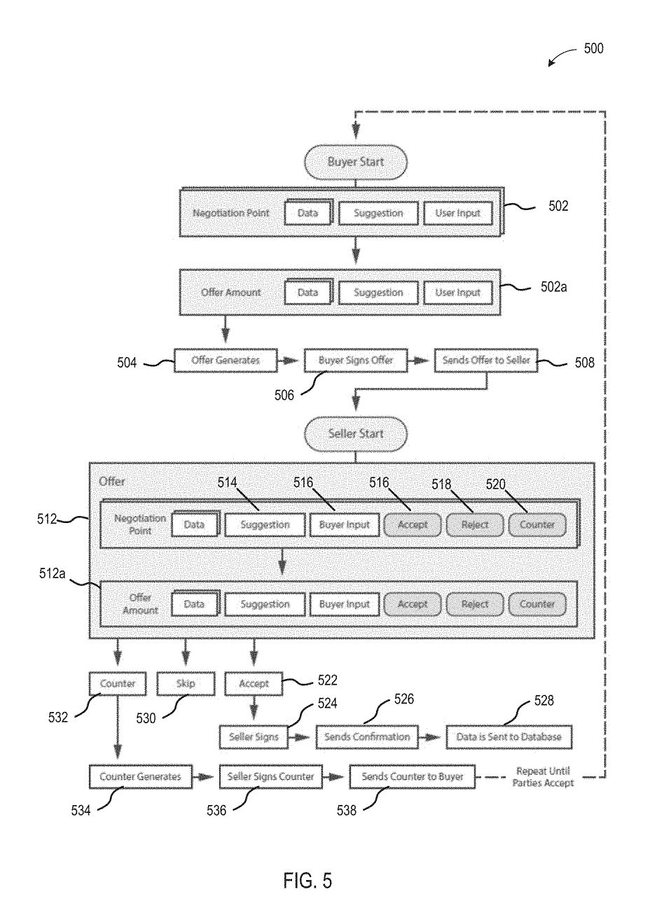

FIG. 5 is a flow diagram of a method 500 of electronically conducting a negotiation between parties, according to another embodiment. FIG. 5 shows how a buyer may begin a negotiation by addressing 502 a number of negotiation points, such as addressing 502a an offer amount. Relevant data is compiled and processed to generate a suggested input value, and user input is received indicating the buyer's value for the negotiation point. Once the negotiation points are addressed, an offer is generated 504, signed 506 by the buyer, and transmitted 508 to the seller.

The seller receives the offer and also addresses 512 the negotiation points, including the offer amount 512a. Relevant data is compiled and processed to provide a suggested 514 input value from the seller's perspective. The seller can also view the buyer's input relative to the negotiation point. The seller can choose to accept 516, reject 518, or counter 520 the buyer's value for each negotiation point.

If the seller accepts 522 all of the buyer input values for the negotiation points of the offer, then confirmation of acceptance (e.g., the seller can optionally sign) and closure of the negotiation is generated 524 and transmitted 526. The confirmation may be transmitted 528 to a database for storage.

If the seller counters 532 one or more of the buyer input values with a different value, then a counter-offer is generated 534, signed 536 by the seller, and transmitted 538 to the buyer for the buyer to review in a similar manner.

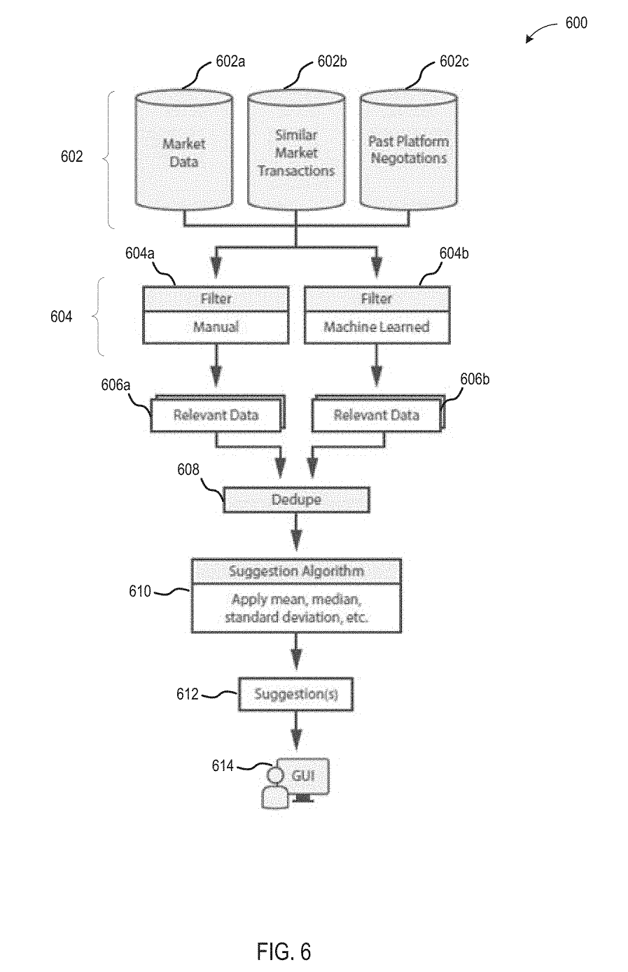

FIG. 6 is a relational diagram of a dynamic database 600 of a system for presenting information to reduce information asymmetry between parties in a negotiation. Data is gathered, compiled, accessed, or otherwise obtained 602 from one or more data sources. The data may include market data 602a, information pertaining to similar market transactions 602b, and past negotiations 602c facilitated by the disclosed embodiments. The data is filtered 604, by one or both of a manual filter 604a (e.g., an address, zip code, other search term provided manually by a user) and a machine learned filter 604b (e.g., filter developed based on user interaction with the system). The data is filtered to identify relevant data 606a, 606b. If both manual and machine filters are applied to the data, two sets of relevant data may be identified, and should be deduped 608 to reduce redundancy. A suggestion algorithm is applied 610 to the relevant data (or the relevant data is provided as an input to the suggestion algorithm) to produce suggestions 612 (e.g., suggested values) for negotiation points. The suggestion algorithm 610 may include applying a mean, a median, a standard deviation, or the like, and then increasing such output by one or more percentage deviations according to a negotiation type or other profile preference. The resulting suggestions 612 can be provided for presentation 614 on a graphical user interface for viewing by a user.

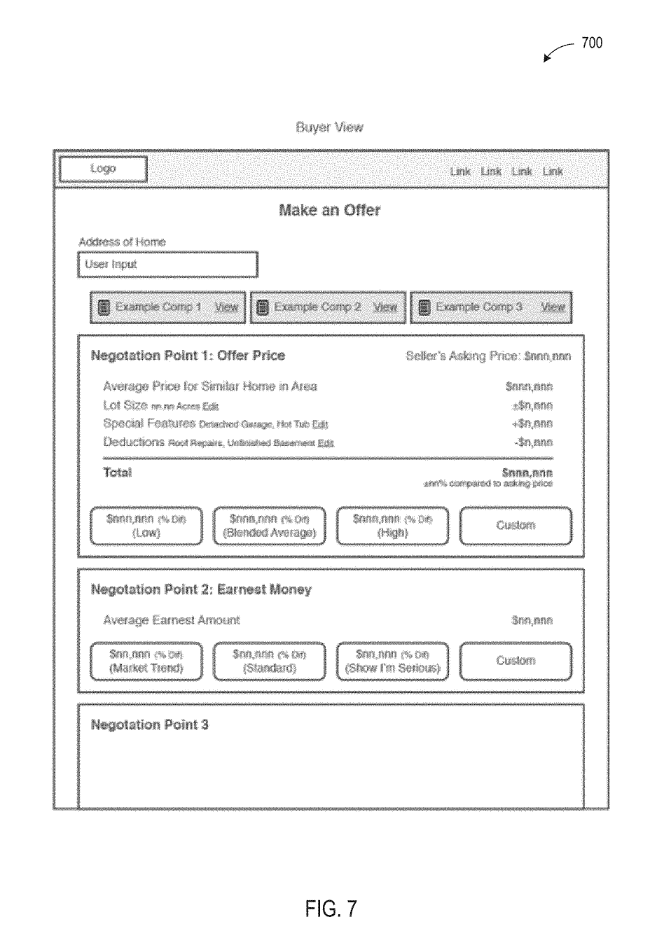

FIG. 7 is a user interface 700 (e.g., a buyer interface) of a buyer portal of a system for presenting information to reduce information asymmetry between parties in a negotiation, according to one embodiment of the present disclosure. The user interface 700 presents relevant information to one or more negotiation points (e.g., offer price) according to a buyer perspective. The buyer perspective may be according to a user profile of the buyer (e.g., a buyer profile) as stored in program data of a system. The user interface 700 may also include input components for receiving buyer input values for one or more negotiation points.

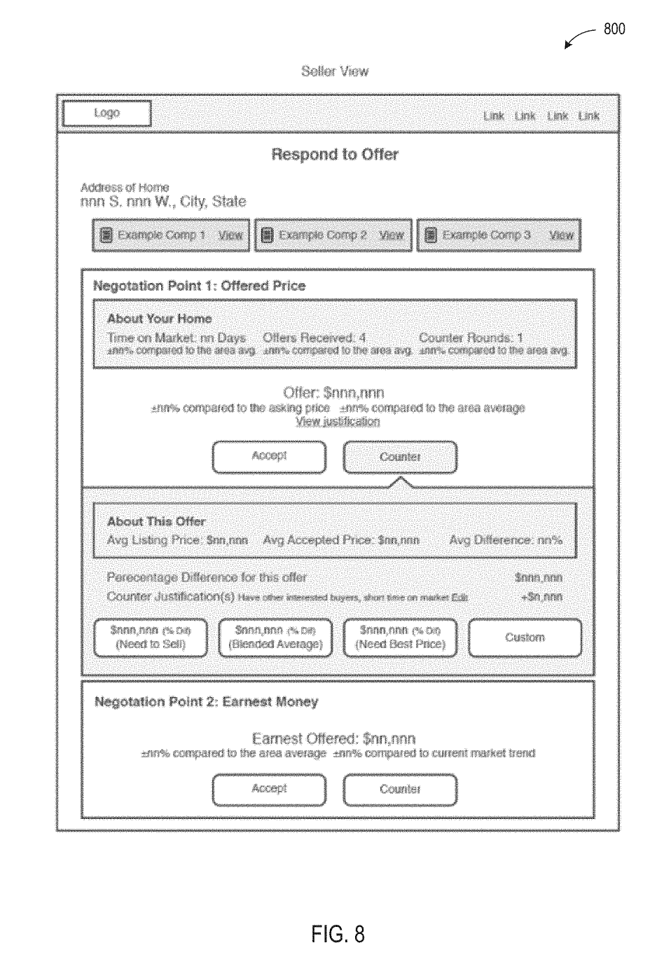

FIG. 8 is a user interface 800 (e.g., a seller interface) of a seller portal of a system for presenting information to reduce information asymmetry between parties in a negotiation, according to one embodiment of the present disclosure. The user interface 800 presents relevant information to one or more negotiation points (e.g., offer price) according to a seller perspective. The relevant data may be the same relevant data as presented to the buyer by the buyer user interface 700. In some embodiments, the relevant data may be a set of data that is different, albeit overlapping with the buyer set of relevant data. In still other embodiments, the relevant data may be a set of data completely different (and mutually exclusive from) the buyer set of relevant data. The seller perspective may be according to a user profile of the seller (e.g., a seller profile) as stored in program data of a system. The user interface 800 may also include input components for receiving seller input values for one or more negotiation points.

As can be appreciated, other methods and processes are available and included in the descriptions above describing operation of the system embodiments and are within the scope of the present disclosure.

### Example Embodiments

Some examples of embodiments of systems and methods of anonymized transparent exchange of information are provided below.

Example 1 is a system for presenting information to reduce information asymmetry between parties in a negotiation. The system includes one or more processors, and electronic memory accessible by the one or more processors, the electronic memory to store a set of negotiation points and to store an electronic negotiation record including values for the set of negotiation points. The system includes a network interface to enable communication with one or more computing devices over an electronic communication network, and a buyer portal to, by the one or more processors, traverse the set of negotiation points, where, for each negotiation point, the buyer portal is to obtain relevant data from a data source for presentation, present a buyer perspective view of the relevant data obtained for the negotiation point, and receive for storage in the electronic negotiation record in the electronic memory a buyer input value for the negotiation point. The system includes a seller portal to, by the one or more processors, traverse the set of negotiation points, where for each negotiation point, the seller portal is to present an associated buyer input value for the negotiation point, obtain relevant data from the data source for presentation, present a seller perspective view of the relevant data obtained for the negotiation point, and receive for storage in the electronic negotiation record in the electronic memory a seller input value for the negotiation point.

Example 2 is the system of Example 1, where the buyer portal is further to process the relevant data to generate a suggested initial buyer value for the negotiation point.

Example 3 is the system of Example 2, where the buyer portal is designed to receive a buyer negotiation style input indicating a preferred negotiation style of a buyer, and where the buyer portal generates the suggested initial buyer value based on the relevant data and the preferred negotiation style of the buyer.

Example 4 is the system of Example 1, where the buyer portal is further to generate a buyer offer including the buyer input values for the set of negotiation points, and where the seller portal is further designed to present the buyer offer.

Example 5 is the system of Example 1, where the buyer portal is to present the buyer perspective view to a buyer client computing device over a network.

Example 6 is the system of Example 1, where the seller portal is further to process the relevant data to generate a suggested initial seller value for the negotiation point.

Example 7 is the system of Example 6, where the seller portal is designed to receive a seller negotiation style input indicating a preferred negotiation style of a seller, and where the seller portal generates the suggested initial seller value based on the relevant data and the preferred negotiation style of the seller.

Example 8 is the system of Example 1, where the seller portal is further to generate a seller counter-offer including the seller input values for the set of negotiation points, and where the buyer portal is further to present the seller counter-offer.

Example 9 is the system of Example 1, where the seller portal is to present the seller perspective view to a seller client computing device over a network.

Example 10 is the system of Example 1, where the seller input value for the negotiation point includes an acceptance of the buyer input value.

Example 11 is the system of Example 1, where the seller input value for the negotiation point includes a rejection of the buyer input value.

Example 12 is the system of Example 1, where the seller input value for the negotiation point includes a counter-value that is different from the buyer input value.

Example 13 is the system of Example 1, further includes an agreement engine to compare the seller input value of each negotiation point with a buyer input value for that negotiation point and determine that agreement is achieved and to present a manifestation that the agreement is achieved.

Example 14 is a system for electronically conducting a negotiation between parties. The system includes one or more processors, and an electronic memory accessible by the one or more processors, the electronic memory to store an electronic negotiation script including a set of negotiation points and to store an electronic negotiation record including values for the set of negotiation points. The system includes a network interface to enable communication with one or more computing devices over an electronic communication network, and a buyer portal to, by the one or more processors, traverse the set of negotiation points of the script, where, for each negotiation point, the buyer portal is to obtain over a network relevant data from a first set of one or more data sources for presentation to a user of the buyer portal, process the relevant data to generate a suggested initial buyer value for the negotiation point, present a buyer perspective view of the relevant data obtained for the negotiation point, and receive for storage in the electronic negotiation record in the electronic memory a buyer input value for the negotiation point. The system includes a seller portal to, by the one or more processors, traverse the set of negotiation points of the script, where for each negotiation point, the seller portal is to present an associated buyer input value for the negotiation point, obtain relevant data from a second set of data sources for presentation to a user of the seller portal, process the relevant data to generate a suggested initial seller value for the negotiation point, present a seller perspective view of the relevant data obtained for the negotiation point, and receive for storage in the electronic negotiation record in the electronic memory a seller input value for the negotiation point.

Example 15 is a computer-implemented method for electronically conducting a negotiation between parties. The method includes traversing by one or more processors a set of negotiation points stored electronically in a memory accessible by the one or more processors. The method includes for each negotiation point of the set of negotiation points: obtaining over an electronic communication network relevant data from a first set of data sources and pertaining to the negotiation point, processing by the one or more processors the relevant data for the negotiation point, including values of one or more similar negotiation points, to generate a suggested initial buyer value for the negotiation point, presenting a buyer perspective view of the relevant data obtained for the negotiation point, and receiving for storage in an electronic negotiation record in the electronic memory a buyer input value for the negotiation point. The method includes for each negotiation point of the set of negotiation points traversing by the one or more processors the set of negotiation points, and for each negotiation of the set of negotiation points: presenting an associated buyer input value for the negotiation point, processing the relevant data for the negotiation point to compare the buyer input value to values for one or more similar negotiation points obtained in the relevant data and generate a suggested initial seller value for the negotiation point, presenting a seller perspective view of the relevant data for the negotiation point, and receiving for storage in the electronic negotiation record in the electronic memory a seller input value for the negotiation point, comparing the seller input value of each negotiation point with a buyer value for that negotiation point to determine that agreement is achieved, and presenting a manifestation that the agreement is achieved.

Example 16 is the method of Example 15, where presenting the buyer perspective view of the relevant data obtained for the negotiation point includes transmitting over the electronic communication network the buyer perspective view to a buyer client computing device.

Example 17 is the method of Example 15, where presenting the seller perspective view of the relevant data obtained for the negotiation point includes transmitting over the electronic communication network the seller perspective view to a seller client computing device.

Example 18 is a system for presenting information to reduce information asymmetry between parties in a negotiation. The system includes one or more processors, electronic memory accessible by the one or more processors, the electronic memory to store a set of negotiation points and to store an electronic negotiation record including values for the set of negotiation points, and a network interface to enable communication with one or more computing devices over an electronic communication network. The system also includes a party portal to, by the one or more processors: traverse the set of negotiation points a first pass, where for each negotiation point the party portal is to obtain relevant data from a data source for presentation, present a first perspective view of the relevant data according to a first party profile, and receive for storage in the electronic negotiation record in the electronic memory a first party input value for the negotiation point, and traverse the set of negotiation points a second pass, where for each negotiation point, the party portal is to present an associated buyer input value for the negotiation point, obtain relevant data from the data source for presentation, present a second perspective view of the relevant data according to a second party profile, and receive for storage in the electronic negotiation record in the electronic memory a second party input value for the negotiation point.

Example 19 is the system of Example 18, where the party portal presents the first perspective view via an electronic network to a first party client computing device.

Example 20 is the system of Example 18, where the party portal presents the second perspective view via an electronic network to a second party client computing device.

Example 21 is a system for facilitating an electronic negotiation. The system comprises one or more processors, an electronic memory, a network interface, a first perspective portal, and a second perspective portal. The electronic memory is accessible by the one or more processors and is to store a set of negotiation points and to store an electronic negotiation record including values for the set of negotiation points. The network interface is to enable communication with one or more computing devices over an electronic communication network. The first perspective portal is to, by the one or more processors, traverse the set of negotiation points. For each negotiation point, the first perspective portal is to obtain relevant data from a data source for presentation, present a first perspective view of the relevant data obtained for the negotiation point, and receive for storage in the electronic negotiation record in the electronic memory a first perspective input value for the negotiation point. The second perspective portal is to, by the one or more processors, traverse the set of negotiation points. For each negotiation point, the second perspective portal is to present an associated first perspective input value for the negotiation point, obtain relevant data from the data source for presentation, present a second perspective view of the relevant data obtained for the negotiation point, and receive for storage in the electronic negotiation record in the electronic memory a second perspective input value for the negotiation point.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media or machine-readable media suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the software module. Indeed, a software module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Those skilled in the art will appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

While the principles of this disclosure have been shown in various embodiments, many modifications of structure, arrangements, proportions, elements, materials, and components, used in practice, which are particularly adapted for a specific environment and operating requirements, may be used without departing from the principles and scope of this disclosure. These and other changes or modifications are intended to be included within the scope of the present disclosure.

1. A system for presenting information to reduce information asymmetry between parties in a negotiation, the system comprising:
one or more processors;
electronic memory accessible by the one or more processors, the electronic memory to store a set of negotiation points and to store an electronic negotiation record including values for the set of negotiation points;
a network interface to enable communication with one or more computing devices over an electronic communication network;
a buyer portal to, by the one or more processors, traverse the set of negotiation points, wherein, for each negotiation point, the buyer portal is to obtain relevant data from a data source for presentation, present a buyer perspective view of the relevant data obtained for the negotiation point, and receive for storage in the electronic negotiation record in the electronic memory a buyer input value for the negotiation point; and
a seller portal to, by the one or more processors, traverse the set of negotiation points, wherein for each negotiation point, the seller portal is to present an associated buyer input value for the negotiation point, obtain relevant data from the data source for presentation, present a seller perspective view of the relevant data obtained for the negotiation point, and receive for storage in the electronic negotiation record in the electronic memory a seller input value for the negotiation point.

2. The system of claim 1, wherein the buyer portal is further to process the relevant data to generate a suggested initial buyer value for the negotiation point.

3. The system of claim 2, wherein the buyer portal is configured to receive a buyer negotiation style input indicating a preferred negotiation style of a buyer, and
wherein the buyer portal generates the suggested initial buyer value based on the relevant data and the preferred negotiation style of the buyer.

4. The system of claim 1, wherein the buyer portal is further to generate a buyer offer comprising the buyer input values for the set of negotiation points, and
wherein the seller portal is further configured to present the buyer offer.

5. The system of claim 1, wherein the buyer portal is to present the buyer perspective view to a buyer client computing device over a network.

6. The system of claim 1, wherein the seller portal is further to process the relevant data to generate a suggested initial seller value for the negotiation point.

7. The system of claim 6, wherein the seller portal is configured to receive a seller negotiation style input indicating a preferred negotiation style of a seller, and
wherein the seller portal generates the suggested initial seller value based on the relevant data and the preferred negotiation style of the seller.

8. The system of claim 1, wherein the seller portal is further to generate a seller counter-offer comprising the seller input values for the set of negotiation points, and
wherein the buyer portal is further to present the seller counter-offer.

9. The system of claim 1, wherein the seller portal is to present the seller perspective view to a seller client computing device over a network.

10. The system of claim 1, wherein the seller input value for the negotiation point comprises an acceptance of the buyer input value.

11. The system of claim 1, wherein the seller input value for the negotiation point comprises a rejection of the buyer input value.

12. The system of claim 1, wherein the seller input value for the negotiation point comprises a counter-value that is different from the buyer input value.

13. The system of claim 1, further comprising an agreement engine to compare the seller input value of each negotiation point with a buyer input value for that negotiation point and determine that agreement is achieved and to present a manifestation that the agreement is achieved.

14. A computer-implemented method for electronically conducting a negotiation between parties, the method comprising:
traversing by one or more processors a set of negotiation points stored electronically in a memory accessible by the one or more processors,
for each negotiation point of the set of negotiation points:
obtaining over an electronic communication network relevant data from a first set of data sources and pertaining to the negotiation point,
processing by the one or more processors the relevant data for the negotiation point, including values of one or more similar negotiation points, to generate a suggested initial buyer value for the negotiation point,
presenting a buyer perspective view of the relevant data obtained for the negotiation point, and
receiving for storage in an electronic negotiation record in the electronic memory a buyer input value for the negotiation point;
traversing by the one or more processors the set of negotiation points; and
for each negotiation of the set of negotiation points:
presenting an associated buyer input value for the negotiation point,
processing the relevant data for the negotiation point to compare the buyer input value to values for one or more similar negotiation points obtained in the relevant data and generate a suggested initial seller value for the negotiation point,
presenting a seller perspective view of the relevant data for the negotiation point, and
receiving for storage in the electronic negotiation record in the electronic memory a seller input value for the negotiation point;
comparing the seller input value of each negotiation point with a buyer value for that negotiation point to determine that agreement is achieved; and
presenting a manifestation that the agreement is achieved.

15. The method of claim 14, wherein presenting the buyer perspective view of the relevant data obtained for the negotiation point comprises transmitting over the electronic communication network the buyer perspective view to a buyer client computing device.

16. The method of claim 14, wherein presenting the seller perspective view of the relevant data obtained for the negotiation point comprises transmitting over the electronic communication network the seller perspective view to a seller client computing device.

17. A system for presenting information to reduce information asymmetry between parties in a negotiation, the system comprising:
one or more processors;
electronic memory accessible by the one or more processors, the electronic memory to store a set of negotiation points and to store an electronic negotiation record including values for the set of negotiation points;
a network interface to enable communication with one or more computing devices over an electronic communication network;
a party portal to, by the one or more processors:
traverse the set of negotiation points a first pass, wherein for each negotiation point the party portal is to obtain relevant data from a data source for presentation, present a first perspective view of the relevant data according to a first party profile, and receive for storage in the electronic negotiation record in the electronic memory a first party input value for the negotiation point, and
traverse the set of negotiation points a second pass, wherein for each negotiation point, the party portal is to present an associated buyer input value for the negotiation point, obtain relevant data from the data source for presentation, present a second perspective view of the relevant data according to a second party profile, and receive for storage in the electronic negotiation record in the electronic memory a second party input value for the negotiation point.

18. The system of claim 17, wherein the party portal presents the first perspective view via an electronic network to a first party client computing device.

19. The system of claim 17, wherein the party portal presents the second perspective view via an electronic network to a second party client computing device.
